(19) United States
(12) Patent Application Publication
(10) Pub. No.: US 2025/0287140 A1
(43) Pub. Date: Sep. 11, 2025

(54) WOOFER SYSTEM, ACOUSTIC SYSTEM, SEAT, AND MOBILE OBJECT

(71) Applicant: Panasonic Automotive Systems Co., Ltd., Kanagawa (JP)

(72) Inventors: Shinya KAGAWA, Osaka (JP); Hiroyuki MORIMOTO, Osaka (JP); Takayuki DAN, Mie (JP); Hidetoshi ASADA, Osaka (JP)

(73) Assignee: Panasonic Automotive Systems Co., Ltd., Kanagawa (JP)

(21) Appl. No.: 19/062,955

(22) Filed: Feb. 25, 2025

(30) Foreign Application Priority Data
Mar. 5, 2024 (JP) 2024-032683

(51) Int. Cl. H04R 1/28; H04R 1/02; H04R 1/26; H04R 1/34

(52) U.S. Cl. CPC H04R 1/2803; H04R 1/025; H04R 1/26; H04R 1/345; H04R 2499/13

(57) ABSTRACT

A woofer system that is to be attached to a seat includes a woofer and a sound path element that forms a sound path that leads a sound output by the woofer. The sound path element includes an opening arranged close to an ear of a listener who sits on the seat.

### CROSS REFERENCE TO RELATED APPLICATION

The present application is based on and claims priority of Japanese Patent Application No. 2024-032683 filed on Mar. 5, 2024.

### FIELD

The present disclosure relates to a woofer system attached to a seat, an acoustic system including the woofer system, a seat into which the woofer system is incorporated, and a mobile object including the woofer system.

### BACKGROUND

Conventionally, a woofer that produces sounds in a relatively low frequency sound range tends to be arranged at a position apart from listeners. In this case, it is necessary to increase the sound level of sounds produced from the woofer to allow the listeners to listen to the sounds at an adequate sound level. However, the sounds increased in the sound level may be noise to non-listeners. Moreover, when the sounds are produced in, for example, a listening room, sounds leaked outside may be considered to be noise.

For example, Patent Literature (PTL) 1 discloses a technique for arranging a woofer near a listener by attaching the woofer to a seat that the listener sits on.

### CITATION LIST

### Patent Literature

PTL 1: Japanese Unexamined Patent Application Publication No. 2006-020163

### SUMMARY

However, the woofer according to PTL 1 can be improved upon.

In view of this, the present disclosure provides a woofer system, an acoustic system, a seat, and a mobile object which are capable of improving upon the above related art.

A woofer system according to one aspect of the present disclosure is a woofer system to be attached to a seat. The woofer system includes a woofer, and a sound path element that forms a sound path that leads a sound output by the woofer. The sound path element includes an opening arranged close to an ear of a listener who sits on the seat.

An acoustic system according to one aspect of the present disclosure includes: a woofer system that is to be attached to a seat and includes a woofer and a sound path element that forms a sound path that leads a sound output by the woofer, where the sound path element includes an opening arranged close to an ear of a listener who sits on the seat; and a loudspeaker that is attached to the seat in a vicinity of the ear of the listener who sits on the seat, and reproduces an acoustic signal in a mid-to-high frequency sound range that is a range including frequencies higher than frequencies at which the woofer reproduces an acoustic signal.

A seat according to one aspect of the present disclosure includes a woofer, and a sound path element that forms a sound path that leads a sound output by the woofer. The sound path element includes an opening arranged close to an ear of a listener who sits on the seat.

A mobile object according to one aspect of the present disclosure includes at least one woofer system that is to be attached to a seat and includes a woofer and a sound path element that forms a sound path that leads a sound output by the woofer, where the sound path element includes an opening arranged close to an ear of a listener who sits on the seat or a seat that includes a woofer and a sound path element that forms a sound path that leads a sound output by the woofer, where the sound path element includes an opening arranged close to an ear of a listener who sits on the seat.

A woofer system, an acoustic system, a seat, and a mobile object according to one aspect of the present disclosure are capable of improving upon the above related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective front view of an acoustic system attached to a seat.

FIG. 2 is a perspective back view of the acoustic system attached to the seat.

FIG. 3 is a perspective front view of a woofer system.

FIG. 4 is a perspective front view of the inside of the woofer system.

FIG. 5 is a perspective back view of the woofer system.

FIG. 6 is a perspective back view of the inside of the woofer system.

FIG. 7 is a perspective front view of the inside of a woofer system according to Example 1.

FIG. 8 is a perspective back view of a woofer system according to Example 2.

FIG. 9 is a perspective front view of the inside of the woofer system according to Example 2.

FIG. 10 is a diagram illustrating a mobile object that includes the acoustic system.

FIG. 11 is a perspective back view of a seat into which the woofer system is incorporated.

### DESCRIPTION OF EMBODIMENT

Hereinafter, an embodiment of a woofer system, an acoustic system, and a mobile object according to the present disclosure will be described with reference to the drawings. Note that the following embodiment is a mere example presented to describe the present disclosure, and thus is not intended to limit the present disclosure. For example, the shapes, structures, materials, elements, relative positional relationships, connection states, numerical values, mathematical expressions, details of steps in methods, and the orders of the steps, etc. presented in the embodiment below are mere examples, therefore may include contents not described below. Moreover, geometrical expressions, such as parallel and orthogonal, may be used, but these expressions do not denote mathematical strictness. These expressions include substantially allowable errors, deviations, etc. Expressions, such as simultaneous and identical, also include a substantially allowable range of errors, etc.

The drawings are schematic diagrams on which emphases, omissions, and/or proportional adjustments are performed as appropriate to describe the present disclosure. Accordingly, the drawings are different from the actual shapes, actual positional relationships, and/or actual proportions. In addition, the X axis, Y axis, and Z axis which may be shown in the drawings denote an orthogonal coordinate system optionally set for describing the drawings. In other words, the Z axis is not limited to an axis extended parallel to a vertical direction, and the X axis and the Y axis are not limited to axes present within a horizontal plane.

The following may comprehensively describe a plurality of inventions as one embodiment. Moreover, some contents stated below are described as optional elements relating to the present disclosure.

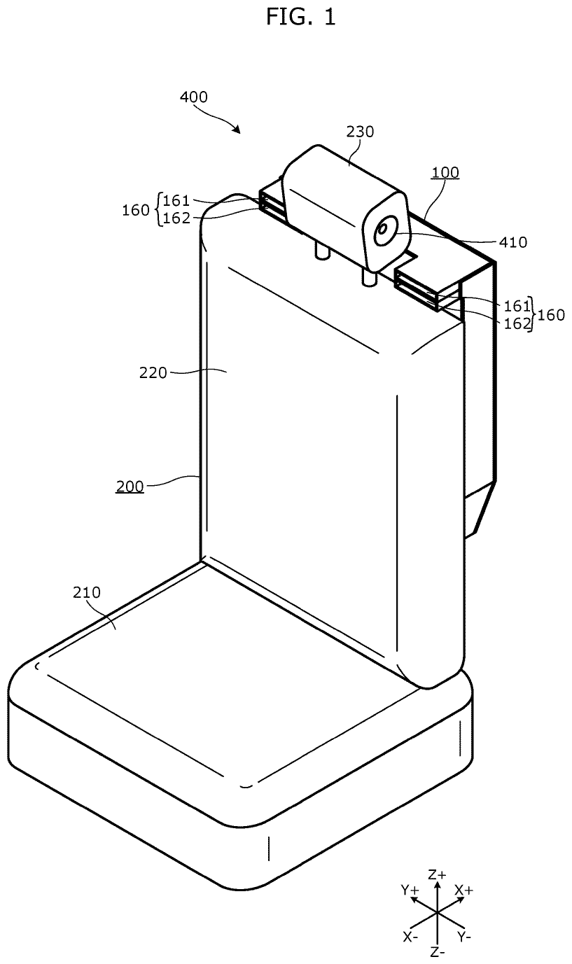

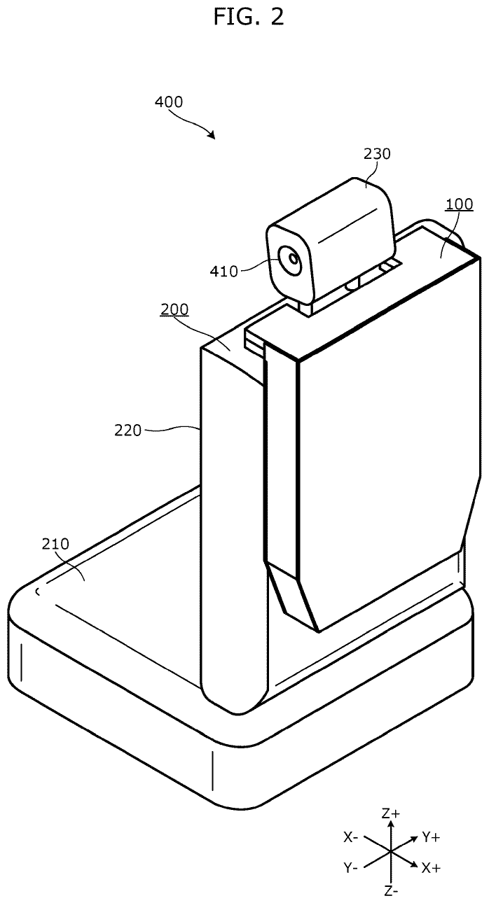

FIG. 1 is a perspective front view of acoustic system 400 attached to seat 200. FIG. 2 is a perspective back view of acoustic system 400 attached to seat 200. It should be noted that although seat 200 and woofer system 100 are simply illustrated by extensive use of straight lines in the drawings, seat 200 may have complicated curved portions, and woofer system 100 may have curved portions that fit the shape of seat 200.

Acoustic system 400 includes woofer system 100 attached to seat 200 and loudspeakers 410 provided in the vicinity of the ears of a lister who sits on seat 200, and reproduces acoustic signals in a mid-to-high frequency sound range that is a range including frequencies higher than frequencies at which woofer 110 reproduces acoustic signals. Loudspeaker 410 may be at least one of a tweeter or a squawker. An acoustic signal in the mid-to-high frequency sound range is a signal whose maximum peak of sound pressure is present in a frequency range above 300 Hz.

In the present embodiment, loudspeakers 410 are attached to headrest 230 of seat 200. Acoustic system 400 includes a plurality of loudspeakers 410, and two loudspeakers 410 are arranged in the vicinity of respective ears of a listener who sits on seat 200. Two openings 160 and the two loudspeakers 410 are respectively arranged adjacent to each other.

As long as seat 200 is a seat that a listener sits on, materials, shapes, etc. of seat 200 are not limited. For example, when seat 200 is provided in an automobile, seat 200 may be, for example, the driver's seat or the passenger's seat next to the driver's seat. Moreover, when seat 200 is arranged in a living room, seat 200 may be a sofa. In the present embodiment, seat 200 includes seat component 210, backrest component 220, and headrest 230. Seat component 210 is one of structural components of seat 200 which supports the buttocks and thighs of a listener who sits on seat 200. Backrest component 220 is one of the structural components of seat 200 which supports the back of a listener who sits on seat 200. Headrest 230 is one of the structural components of seat 200 which is arranged at the back of the head of a listener who sits on seat 200. Seat component 210, backrest component 220, and headrest 230 each include, for example, an outer skin component made of leather (including synthetic leather), resin, fabric, etc. and a cushion component covered by the outer skin component.

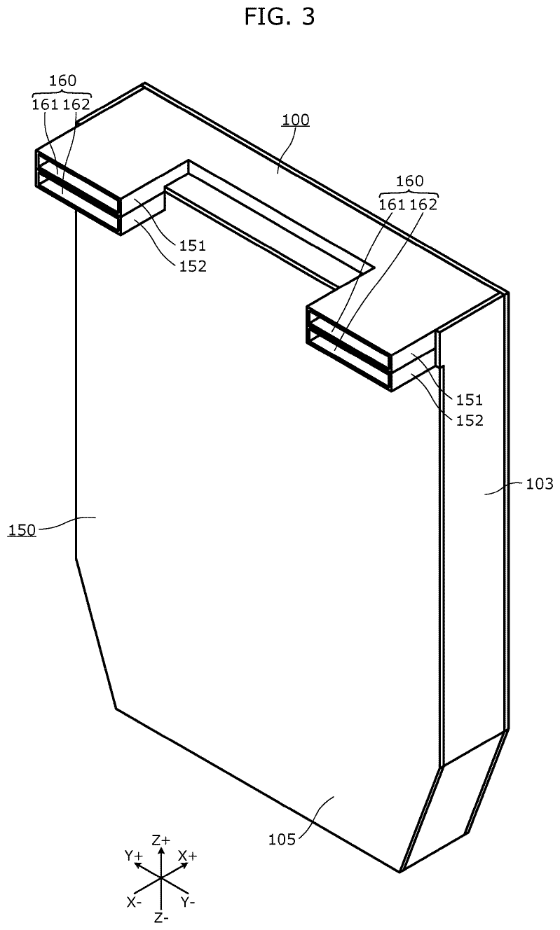

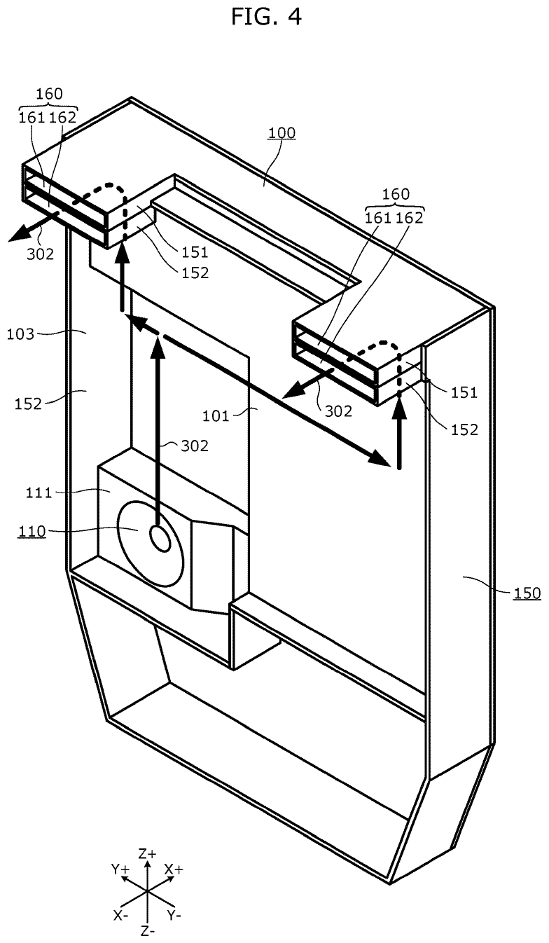

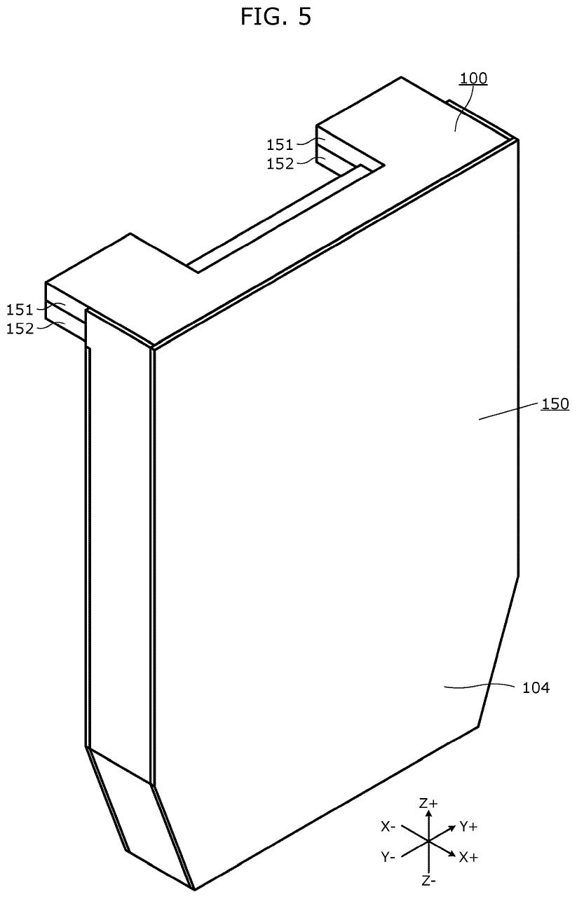

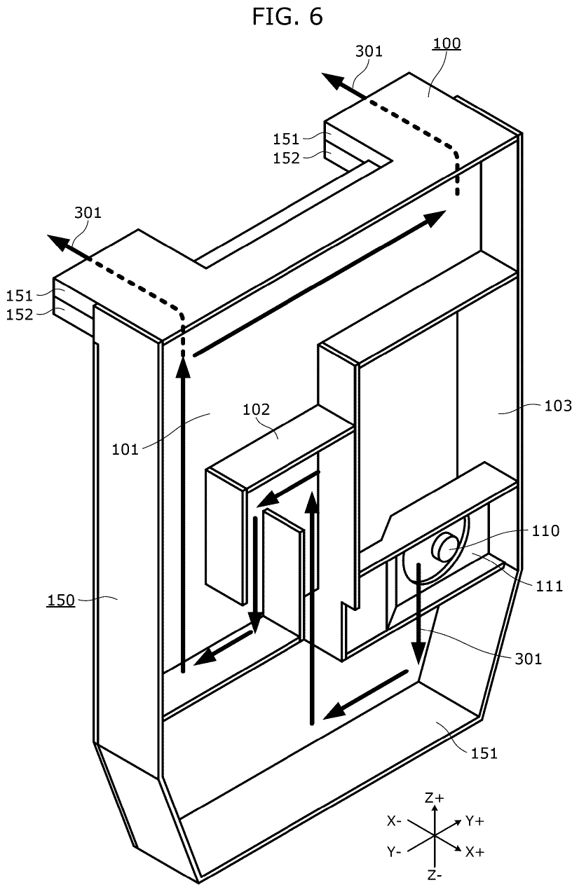

FIG. 3 is a perspective front view of woofer system 100. FIG. 4 is a perspective front view of an inside of woofer system 100. FIG. 5 is a perspective back view of woofer system 100. FIG. 6 is a perspective back view of the inside of the woofer system. Woofer system 100 is a device that is attached to seat 200, and emits sounds close to the ears of a listener who sits on seat 200. Woofer system 100 may be integrally attached to seat 200 or may be an individual element separable from seat 200. In the present embodiment, woofer system 100 is a device attachable to and detachable from the back surface of backrest component 220 of seat 200, and includes woofer 110 and sound path element 150.

Woofer 110 is a loudspeaker that reproduces audio signals in a low frequency sound range. An acoustic signal in the low frequency sound range is a signal whose maximum peak of sound pressure is present in a frequency range of from 20 Hz to 300 Hz (particularly, at most 100 Hz). The shape and structure of woofer 110 are not limited. As an example of woofer 110, a loudspeaker including a diaphragm, a voice coil, a magnetic circuit, and a frame can be presented. In the present embodiment, woofer 110 is a loudspeaker that includes a cone-shaped diaphragm. In the present embodiment, it should be noted that, in a winding axis direction of a voice coil, a side on which the voice coil is arranged relative to the diaphragm of woofer 110 may be stated as back, and the side opposite thereof may be stated as front.

In the present embodiment, woofer 110 is attached to, as illustrated in FIG. 4 and FIG. 6, enclosure 111 that separates sounds output from the front of woofer 110 and sounds output from the back of woofer 110.

Sound path element 150 is a component that forms a sound path that leads sounds emitted from woofer 110 attached to seat 200 to a desired position. Sound path element 150 includes openings 160 arranged close to the ears of a listener who sits on seat 200. In the present embodiment, sound path element 150 includes rear sound path element 151 (see FIG. 6) that leads sounds output from the back of woofer 110 and front sound path element 152 (see FIG. 4) that leads sounds output from the front of woofer 110.

Rear sound path element 151 is a component that forms a sound path that leads rear sound 301 (arrows in FIG. 6 show the route) output from the back of woofer 110 to rear sound openings 161 arranged close to the ears of a listener who sits on seat 200. The structure of rear sound path element 151 is not limited, but rear sound path element 151 may have a structure in which the phase of rear sound 301 output from rear sound openings 161 agrees with the phase of front sound 302 output from front sound openings 162. The present embodiment adopts a structure that increases a desired frequency level by adjusting at least one of the volume of enclosure 111 (may be absent) that communicates with rear sound path element 151, the cross-section area size of rear sound path element 151, or the length of rear sound path element 151. The cross-section area size of rear sound path element 151 is an area size of a space of rear sound path element 151 that is taken in a plane orthogonal to the traveling direction of rear sound 301.

Rear sound path element 151 may be a tubular component, and, as rear sound openings 161, openings of the tubular component may be arranged close to the ears of a listener who sits on seat 200. In the present embodiment, woofer system 100 includes woofer 110 accommodated inside the box-shaped sound path element 150 and separation component 101 (see FIG. 6) including enclosure 111 that separates rear sound 301 and front sound 302 inside sound path element 150. Rear sound path element 151 includes separation component 101, frame component 103 (see FIG. 6) that is a portion of the outer shell of sound path element 150, rear component 104 (see FIG. 5), and guiding component 102 (see FIG. 6). Rear sound path element 151 includes two rear sound openings 161 arranged in the vicinity of respective ears of a listener who sits on seat 200.

Front sound path element 152 is a component that forms a sound path that leads front sound 302 (arrows in FIG. 4 show the route) output from the front of woofer 110 to front sound openings 162 arranged close to the ears of a listener who sits on seat 200. The structure of front sound path element 152 is not limited, but may be a structure in which the phase of front sound 302 output from front sound openings 162 agrees with the phase of rear sound 301 output from rear sound openings 161. The present embodiment adopts a structure that increases a desired frequency level by adjusting at least one of the volume of enclosure 111 (may be absent as in the present embodiment) that communicates with front sound path element 152, the cross-section area size of front sound path element 152, or the length of front sound path element 152. Note that the frequency level increased by rear sound path element 151 and the frequency level increased by front sound path element 152 may be different. The cross-section area size of front sound path element 152 is an area size of a space of front sound path element 152 that is taken in a plane orthogonal to the traveling direction of front sound 302.

Front sound path element 152 may be a tubular component, and, as front sound openings 162, openings of the tubular component may be arranged close to the ears of a listener who sits on seat 200. In the present embodiment, front sound path element 152 includes separation component 101, frame component 103 (see FIG. 4) that is a portion of the outer shell of sound path element 150, and front component 105 (see FIG. 3). Front sound path element 152 includes two front sound openings 162 arranged in the vicinity of respective ears of a listener who sits on seat 200. The two rear sound openings 161 and the two front sound openings 162 are respectively arranged adjacent to each other.

Note that the present disclosure is not limited to the above-described embodiment. For example, the present disclosure may include different embodiments achieved by combining optional elements described in the present description or by excluding some of the elements described in the present description. Moreover, the present disclosure also includes variations obtained by applying various modifications conceivable to those skilled in the art to the above-described embodiment within the scope not departing from the spirit of the present disclosure, namely, the meaning of wording recited in the claims.

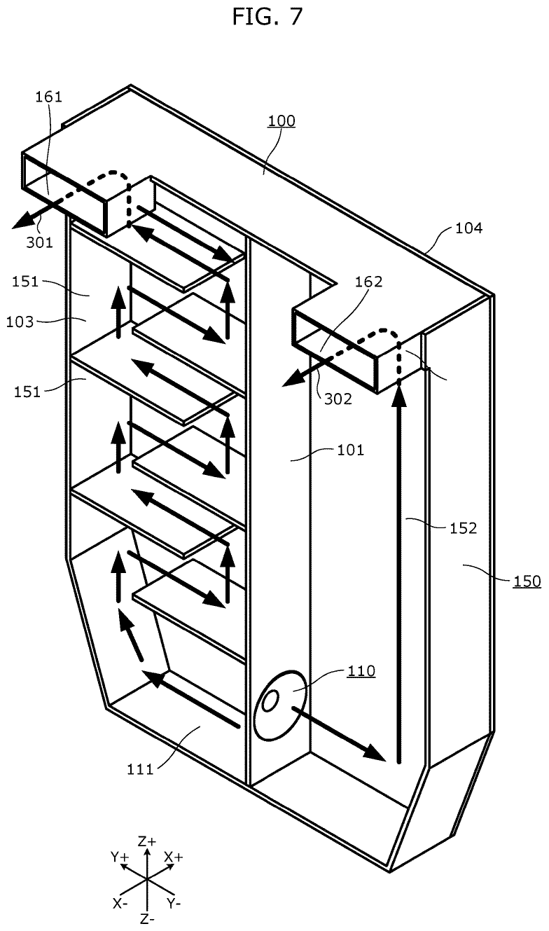

For example, as illustrated in FIG. 7, woofer system 100 may include front sound opening 162 arranged close to one of the ears of a listener who sits on seat 200 and rear sound opening 161 arranged close to the other of the ears of the listener.

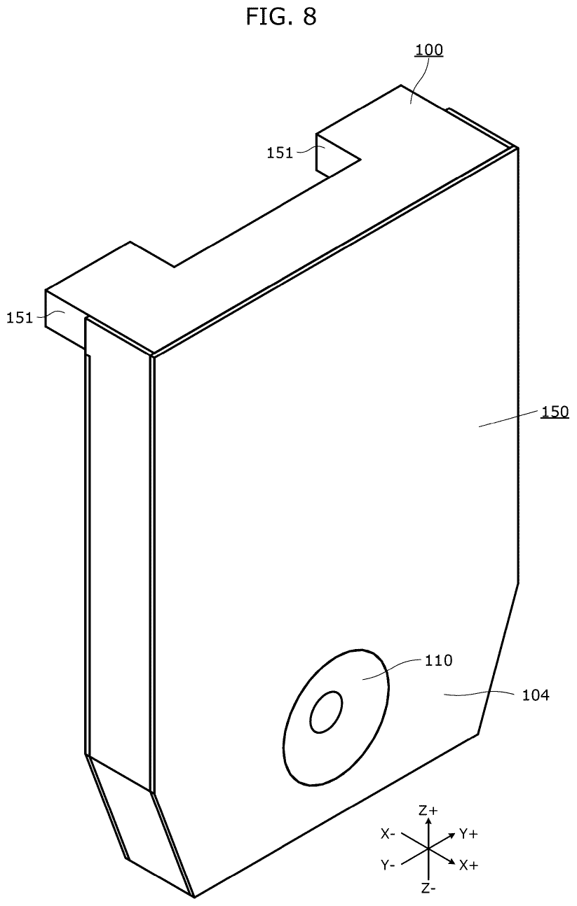

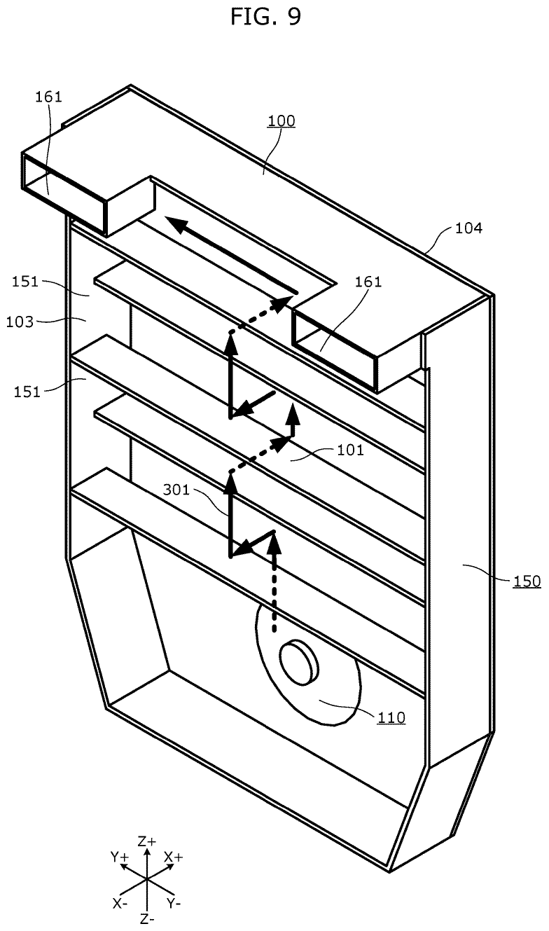

Moreover, as illustrated in FIG. 8 and FIG. 9, woofer system 100 may include rear sound path element 151, but need not include front sound path element 152. Rear sound path element 151 may include rear sound opening 161 arranged close to the right ear of a listener who sits on seat 200 and rear sound opening 161 arranged close to the left ear of the listener.

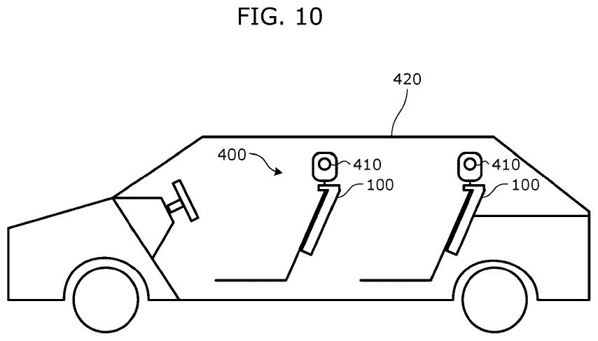

In addition, as illustrated in FIG. 10, one or more woofer systems 100 may be provided in mobile object 420, and may build acoustic system 400 inside mobile object 420 together with loudspeakers 410 provided in mobile object 420.

Moreover, woofer system 100 may be arranged for a plurality of seats inside mobile object 420.

Although woofer 110 has been described as being arranged behind backrest component 220, woofer 110 may be arranged below the bottom surface of seat component 210 or inside seat component 210, and rear sound path element 151 and front sound path element 152 may be arranged inside backrest component 220. This allows adoption of large-sized woofer 110.

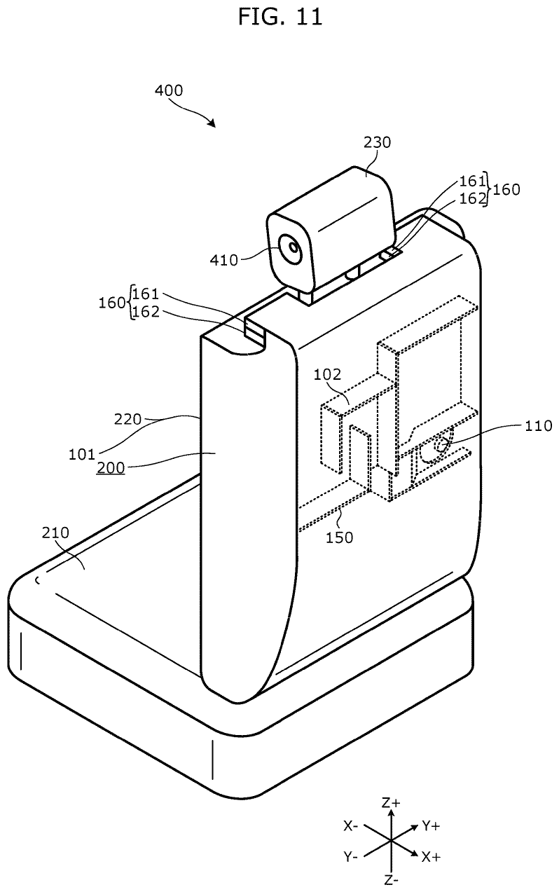

Moreover, as illustrated in FIG. 11, seat 200 may be a seat into which woofer 110 and sound path element 150 that forms a sound path that leads sounds output by woofer 110 are incorporated, and sound path element 150 may include openings arranged close to the ears of a listener who sits on seat 200. Furthermore, seat 200 may include loudspeakers 410 that reproduce audio signals in a mid-to-high frequency sound range that is a range including frequencies higher than frequencies at which woofer 110 reproduces acoustic signals.

Woofer system 100 according to aspect 1 includes woofer 110 to be attached to seat 200, and sound path element 150 that forms a sound path that leads a sound output by woofer 110. Sound path element 150 includes opening 160 arranged close to an ear of a listener who sits on seat 200.

According to aspect 1, low frequency sounds can be made close to the ears of a listener as compared to the case where woofer 110 is arranged at a position apart from the listener. Accordingly, the sound level of sounds output by woofer 110 can be decreased, and the sound level of low frequency sounds that non-listeners unwillingly hear can be suppressed. Furthermore, when the sounds are produced in, for example, a listening room, noise produced as a result of the sounds leaked outside can be suppressed. In addition, a reduction in power requirements can be facilitated.

Woofer system 100 according to aspect 2 includes aspect 1 and enclosure 111 that separates a sound output from the front of woofer 110 and a sound output from the back of woofer 110. In woofer system 100, sound path element 150 is rear sound path element 151 including rear sound opening (or rear opening) 161 as opening 160. Rear sound path element 151 leads rear sound 301 output from the back of woofer 110 to rear sound opening 161.

According to aspect 2, sounds output from the back of woofer 110 can be effectively delivered to a listener. This allows the listener to further experience the sensation of low frequency sounds.

Woofer system 100 according to aspect 3 includes aspect 2. In woofer system 100, a desired frequency level is increased by adjusting at least one of a volume of enclosure 111, a cross-section area size of rear sound path element 151, or a length of rear sound path element 151.

Woofer system 100 according to aspect 4 includes aspect 1 or aspect 2 and enclosure 111 that separates a sound output from the front of woofer 110 and a sound output from the back of woofer 110. In woofer system 100, sound path element 150 is front sound path element 152 including front sound opening (or front opening) 162 as opening 160. Front sound path element 152 leads a front sound output from the front of woofer 110 to front sound opening 162.

According to aspect 4, front sounds can be delivered close to the ears of a listener regardless of the attachment position of woofer 110.

Woofer system 100 according to aspect 5 includes aspect 4. In woofer system 100, a desired frequency level is increased by adjusting at least one of a volume of enclosure 111, a cross-section area size of front sound path element 152, or a length of front sound path element 152.

Woofer system 100 according to aspect 6 includes aspect 4. In woofer system 100, a frequency level caused to be increased by a volume of enclosure 111, a cross-section area size of rear sound path element 151, and a length of rear sound path element 151 and a frequency level caused to be increased by a volume of enclosure 111, a cross-section area size of front sound path element 152, and a length of front sound path element 152 are different.

Woofer system 100 according to aspect 7 includes aspect 4. In woofer system 100, front sound opening 162 and rear sound opening 161 are arranged adjacent to each other.

Woofer system 100 according to aspect 8 includes aspect 4. In woofer system 100, front sound opening 162 is arranged close to one of ears, and rear sound opening 161 is arranged close to the other of the ears.

According to aspects 7 and 8, rear sound 301 and front sound 302 output from woofer 110 can be concurrently delivered close to the ears, and thus allow a listener to effectively hear low frequency sounds.

Woofer system 100 according to aspect 9 includes aspect 1. In woofer system 100, sound path element 150 includes a right-side opening 160 arranged close to the right ear of the listener who sits on seat 200 and a left-side opening 160 arranged close to the left ear of the listener.

According to claim 9, low frequency sounds can be delivered close to the ears of a listener while a predetermined space is filled with sounds output from one side of woofer 110.

Acoustic system 400 according to aspect 10 includes: woofer system 100 according to any one of aspects 1 to 9; and a loudspeaker that is attached to the seat in the vicinity of the ear of the listener who sits on the seat, and reproduces an acoustic signal in a mid-to-high frequency sound range that is a range including frequencies higher than frequencies at which the woofer reproduces an acoustic signal.

According to aspect 10, as compared to the case where woofer 110 is arranged at a position apart from a listener, low frequency sounds can be made close to the ears of a listener, and sounds in a wide frequency band from a low frequency sound range to a high frequency sound range can be delivered to the listener. Accordingly, the sound level of sounds output by woofer 110 can be decreased, and the sound level of low frequency sounds that non-listeners unwillingly hear can be suppressed. Furthermore, when the sounds are produced in, for example, a listening room, noise produced as a result of sounds leaked outside can be suppressed. In addition, a reduction in power requirements can be facilitated.

Seat 200 according to aspect 11 includes woofer 110, and sound path element 150 that forms a sound path that leads a sound output by woofer 110. In seat 200, sound path element 150 includes opening 160 arranged close to an ear of a listener who sits on seat 200.

According to aspect 11, low frequency sounds can be made close to the ears of a listener as compared to the case where woofer 110 is arranged at a position apart from the listener. Accordingly, the sound level of sounds output by woofer 110 can be decreased, and the sound level of low frequency sounds that non-listeners unwillingly hear can be suppressed. Furthermore, when the sounds are produced in, for example, a listening room, noise produced as a result of sounds leaked outside can be suppressed. In addition, a reduction in power requirements can be facilitated.

Mobile object 420 according to aspect 12 includes one or more of woofer systems 100 according to aspects 1 to 9 or one or more of the seat according to aspect 11.

According to aspect 12, low frequency sounds can be made close to the ear of a listener as compared to the case where woofer 110 is arranged at a position apart from the listener. Accordingly, leakage of low frequency sounds outside mobile object 420 can be reduced. Therefore, noise produced as a result of sounds leaked outside can be suppressed. In addition, a reduction in power requirements can be facilitated.

While the embodiment has been described herein above, it is to be appreciated that various changes in form and detail may be made without departing from the spirit and scope of the present disclosure as presently or hereafter claimed.

### Further Information about Technical Background to this Application

The disclosure of the following patent application including specification, drawings, and claims are incorporated herein by reference in their entirety: Japanese Patent Application No. 2024-032683 filed on Mar. 5, 2024.

### INDUSTRIAL APPLICABILITY

The present disclosure is applicable to houses and commercial facilities that include seats, and mobile objects, such as automobiles, vessels, aircraft, and construction machinery, which include seats.

1. A woofer system to be attached to a seat, the woofer system comprising:
a woofer; and
a sound path element that forms a sound path that leads a sound output by the woofer, wherein
the sound path element includes an opening arranged close to an ear of a listener who sits on the seat.

2. The woofer system according to claim 1, further comprising:
an enclosure that separates a sound output from front of the woofer and a sound output from back of the woofer, wherein
the sound path element is a rear sound path element including a rear opening as the opening, the rear sound path element leading a rear sound output from the back of the woofer to the rear opening.

3. The woofer system according to claim 2, wherein
a desired frequency level is increased by adjusting at least one of a volume of the enclosure, a cross-section area size of the rear sound path element, or a length of the rear sound path element.

4. The woofer system according to claim 2, further comprising:
an enclosure that separates a sound output from the front of the woofer and a sound output from the back of the woofer, wherein
the sound path element is a front sound path element including a front opening as the opening, the front sound path element leading a front sound output from the front of the woofer to the front opening.

5. The woofer system according to claim 4, wherein
a desired frequency level is increased by adjusting at least one of a volume of the enclosure, a cross-section area size of the front sound path element, or a length of the front sound path element.

6. The woofer system according to claim 4, wherein
a frequency level caused to be increased by a volume of the enclosure, a cross-section area size of the rear sound path element, and a length of the rear sound path element and a frequency level caused to be increased by a volume of the enclosure, a cross-section area size of the front sound path element, and a length of the front sound path element are different.

7. The woofer system according to claim 4, wherein
the front opening and the rear opening are arranged adjacent to each other.

8. The woofer system according to claim 4, wherein
the front opening is arranged close to one of ears, and
the rear opening is arranged close to an other of the ears.

9. The woofer system according to claim 1, wherein
the sound path element includes a right-side opening arranged close to a right ear of the listener who sits on the seat and a left-side opening arranged close to a left ear of the listener.

10. An acoustic system comprising:
the woofer system according to claim 1; and
a loudspeaker that is attached to the seat in a vicinity of the ear of the listener who sits on the seat, and reproduces an acoustic signal in a mid-to-high frequency sound range that is a range including frequencies higher than frequencies at which the woofer reproduces an acoustic signal.

11. A seat comprising:
a woofer; and
a sound path element that forms a sound path that leads a sound output by the woofer, wherein
the sound path element includes an opening arranged close to an ear of a listener who sits on the seat.

12. A mobile object comprising:
one or more of woofer systems each of which is the woofer system according to claim 1.
